(19) United States
(12) Patent Application Publication
(10) Pub. No.: US 2025/0297813 A1
(43) Pub. Date: Sep. 25, 2025

(54) THERMOCHEMICAL SALT HYDRATE SYSTEM FOR ENERGY STORAGE

(71) Applicants: NAIM ENERGY TECHNOLOGIES, LLC, CHICAGO, IL (US); THE REGENTS OF THE UNIVERSITY OF CALIFORNIA, OAKLAND, CA (US)

(72) Inventors: Mohammed FARID, Chicago, IL (US); Ruby-Jean CLARK, Chicago, IL (US); Yana GALAZUTDINOVA, Chicago, IL (US); Sumanjeet KAUR, Oakland, CA (US); Said AL-HALLAJ, Chciago, IL (US)

(73) Assignees: NAIM ENERGY TECHNOLOGIES, LLC, CHICAGO, IL (US); THE REGENTS OF THE UNIVERSITY OF CALIFORNIA, OAKLAND, CA (US)

(21) Appl. No.: 19/078,874

(22) Filed: Mar. 13, 2025

Related U.S. Application Data
(60) Provisional application No. 63/567,024, filed on Mar. 19, 2024.

(51) Int. Cl. F28D 20/00

(52) U.S. Cl. CPC F28D 20/003

(57) ABSTRACT

A chemical-based energy storage system, including a porous matrix structure impregnated with a thermochemical material. The thermochemical material stores and releases thermal energy though a reversible chemical reaction. The thermochemical material desirably includes a salt hydrate, wherein the thermochemical material absorbs thermal energy during a dehydration reaction and discharges stored energy through a hydration reaction. The salt hydrate can be an inorganic salt selected from calcium salts, magnesium salts, sodium salts, strontium salts, lithium salts, and combinations thereof.

### CROSS REFERENCE TO RELATED APPLICATION

This application claims the benefit of U.S. Provisional Application, Ser. No. 63/567,024, filed on 19 Mar. 2024. The co-pending provisional application is hereby incorporated by reference herein in its entirety and is made a part hereof, including but not limited to those portions which specifically appear hereinafter.

### GOVERNMENT SUPPORT CLAUSE

This invention was made with government support under Contract No. DE-AC02-05CH11231 awarded by the U.S. Department of Energy. The government has certain rights in the invention.

### FIELD OF THE INVENTION

This invention relates generally to chemical-based energy storage and, more particularly, to a thermochemical energy storage system using salt hydrates, and methods of making and using, such as in energy regulation in buildings.

### BACKGROUND OF THE INVENTION

Thermochemical energy storage (TCES) has attracted significant attention in recent years due to its advantages associated with very high energy density at the material scale and its suitability for long-term energy storage because of almost zero loss during storage. Despite these advantages, TCES technologies are still in the early stage of development.

A key component of the thermochemical heat storage system is the reactor, where the heat and mass transfer as well as chemical reactions take place. Therefore, a large focus of current TCES studies is on numerical and experimental studies of different thermochemical reactor designs/concepts and TCES materials.

With respect to system configuration, TCES systems can generally be divided into open and closed systems. Open systems work at atmospheric pressure in contact with the environment while closed ones work with pure vapor, circulating in hermetically closed loops. A closed system is usually based on a sorption reactor (heat exchanger), a condenser, and an evaporator, i.e. an open system is less complex in its design. It can be directly connected to the ambient air where the moisture for the sorption process is obtained.

As for the reactor configuration, packed beds, moving beds, and fluidized beds are usually defined as three main technologies. Packed bed reactors are a low-cost solution and the simplest technology compared to other types of reactors for TCES, which makes them an appropriate candidate for technology upscaling and integration. They are easy to build and operate; their main drawbacks are the pressure drop inside the bed, which may induce preferred gas channeling, and the limited available contact surface of the reactants, which may compromise the power and energy output. Another important drawback is the poor heat transfer within the porous bed imposed by its low effective thermal conductivity.

The reacting material in the case of thermochemical packed bed reactors is subjected to different stresses, namely, chemical, mechanical, and thermal stresses. The volume changes due to phase transitions and thermal expansion and shrinkage, together with the pressure induced by the weight of the upper particle layers, cause particle-wall or particle-particle friction, known as ratcheting. In addition, pore reduction caused by particle sintering may create overpressure during gas release in solid-gas thermochemical materials. As a result, particles can crack, or their surface can be eroded, resulting in fines and reallocation of smaller particles which leads to a decrease in the void fraction. These negative effects can be significant on the lowest layers, which are subjected to higher weight loads. Considering the cycling operation nature of the TCES systems and the long life expectancy, it can lead to a significant increase in the pressure drop or to the collapse of the container wall.

There is thus a continuing need for additional and/or improved TCES systems and materials.

### SUMMARY OF THE INVENTION

A general object of the invention is to provide an improved thermochemical energy storage system. Thermochemical materials (TCM) with high storage capacities (e.g., 600 kWh/m³) and negligible self-discharge are uniquely suited as compact, stand-alone units for daily-seasonal storage for heating.

The general object of the invention can be attained, at least in part, through a chemical-based energy storage system, including a porous matrix structure impregnated with a thermochemical material. The thermochemical material preferably stores and releases thermal energy though a reversible chemical reaction.

In embodiments, the thermochemical material comprises a salt hydrate, preferably where the thermochemical salt hydrate absorbs thermal energy during a dehydration reaction and discharges thermal energy through a hydration reaction. In embodiments, the salt hydrate is or includes an inorganic salt selected from calcium salts, magnesium salts, sodium salts, strontium salts, lithium salts, and combinations thereof. Exemplary salt hydrates include, without limitation, sodium phosphate, strontium bromide, strontium chloride, calcium chloride, magnesium sulfate, or combinations thereof.

The matrix can be formed of a porous structure, such as formed of expanded graphite. A plurality of through air passages can be formed through the matrix and used to increase air flow to the impregnated material. The invention includes a method of forming a thermochemical energy storage system, including steps of impregnating a porous matrix structure with a salt hydrate, either before or after forming air passages through the porous matrix structure.

Embodiments of this invention provide very high energy density compared to systems reported in literature, mainly due to the ability to capture moisture well above the quantity usually absorbed chemically (e.g., extensive overhydration). The invention has been shown to be thermally and mechanically stable after more than 80 cycles. Designs of this invention allow for increasing heat charge/discharge rates by increasing the number of holes used for air flow through the graphite structure. The system allows the use of multiple structures (e.g., blocks) with different salts in a cascade system. The structures can be run in parallel or series. Beneficially, the graphite structures are relatively easy to fabricate and impregnate, and at low cost

As used herein, references to “salt hydrates” (also “hydrated salt” or “hydrate”) are to be understood to refer to ‘alloys’ of inorganic salts and water, resulting in a typical crystalline solid of general formula (salt·xH₂O). Their phase change transition is understood as a dehydration or hydration of the salt. Salt hydrates typically melt to either a salt hydrate with fewer moles of water, or to its anhydrous form.

An inorganic salt hydrate is an ionic compound in which a number of water molecules are attracted by the ions and therefore enclosed within its crystal lattice. In embodiments, a general formula of a hydrated salt is MxNy·nH2O. The water molecules inside the crystals of a hydrate generally form coordinate covalent bonds and hydrogen bonds to the positively charged metal ions (cations) of the salt. These water molecules may be referred to as water of crystallization or water of hydration. During heating, hydrated salt loses its water of crystallization by absorbing a certain amount of energy, called the enthalpy of dehydration (ΔHdehyd). While cooling or being exposed to the atmosphere, water molecules from the surroundings are easily captured by salt crystals and release the thermal energy corresponding to ΔHhyd. When heated, a salt hydrate is usually converted either to its anhydrous form or to a salt hydrate with fewer moles of water.

In embodiments of this invention, the thermochemical materials (TCMs) include a reactive pair of inorganic salt and water vapor, such as having theoretical energy densities of at least ˜500 kWh/m³ and negligible self-discharge as energy is stored in chemical bonds, making them uniquely suited as compact, stand-alone solutions for daily-seasonal energy storage in buildings. Suitable salt hydrate TCMs are preferably non-toxic and non-flammable, have a charging temperature of less than 100° C., have fast reaction kinetics, have greater than 500 kWh/m³ energy densities, have deliquescence relative humidity (DRH) of greater than 40% RH to prevent over-hydration, have high cyclability, have a T_{melting}>T_{dehydration} to ensure solid stability, and/or have a low material cost.

Other objects and advantages will be apparent to those skilled in the art from the following detailed description taken in conjunction with the appended claims and drawings.

### BRIEF DESCRIPTION OF THE DRAWINGS

FIG. 1 shows a representative thermochemical energy storage system (TCES) in a building, according to embodiments of this invention.

FIGS. 2 and 3 show exemplary graphite block structures according to embodiments of this invention.

FIGS. 4 and 5 show a thermochemical energy storage system (TCES), according to embodiments of this invention.

FIG. 6 shows graphite block structures formed in the examples described herein.

FIG. 7 is a graph describing examples used in the examples.

FIGS. 8 and 9 show a thermochemical energy storage system set up for the examples herein.

FIGS. 10 and 11 show graphs representing results of the example testing.

FIGS. 12A and 12B show graphite blocks after testing.

FIGS. 13-23 show graphs summarizing results of the example testing described herein.

### DETAILED DESCRIPTION OF THE INVENTION

The present invention provides an improved thermochemical energy storage system, such as for use as stand-alone units for daily-seasonal storage for heating. The invention provides a chemical-based energy storage system including a porous matrix structure impregnated with a thermochemical material. The thermochemical material preferably stores and releases thermal energy though a reversible chemical reaction. In embodiments, the thermochemical material comprises a salt hydrate, preferably where the thermochemical salt hydrate absorbs thermal energy during a dehydration reaction and discharges thermal energy through a hydration reaction.

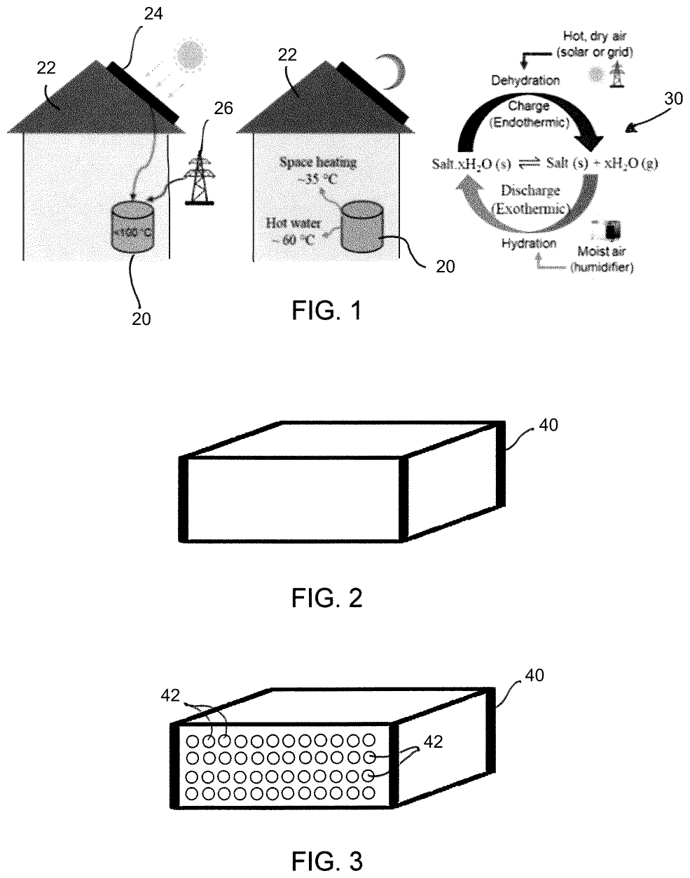

FIG. 1 shows a representative thermochemical energy storage system (TCES) 20 in a building 22, and how it can be charged using solar 24 or grid 26 electricity. Energy sorted in the thermochemical material can be discharged at a desired temperature for thermal end-users. An exemplary reversible solid-gas reaction 30 of the salt hydrate is also illustrated in an open system.

A technical problem of using hydrated salts for energy storage is that the salts cannot be used by themselves to store energy so they must be contained in a structure which allow moisture to diffuse in and out. Previous attempts have been made to use them in combination with different holding materials but with limited success. Embodiments of this invention includes a graphite structure that allows moisture diffusion and also have high thermal conductivity. It is also easy to machine and fabricate in any scale.

FIG. 2 shows an exemplary graphite block structure 40. The block 40 can be formed/molded from expanded graphite flakes to form a porous structure that can be impregnated with the thermochemical material, for example salt hydrate, to form a TCES structure according to embodiments of this invention. To improve moisture transfer to and from the impregnated salt hydrate, FIG. 3 shows the block 40 with a plurality of tubular passageways 42 formed (e.g. drilled) through the graphite block 40. Various sizes, shapes, and configurations are available or the graphite structure and the air passageways, depending on need.

In embodiments of this invention, the salt hydrate is an inorganic salt that does not leak out from the supporting structure during hydration and dehydration. Preferably the percentage loss should not exceed 5% over 200 cycles. Additionally or alternatively, the inorganic salt remains mechanically stable during hydration/dehydration, such as remaining mechanically well integrated over 400 cycles. The inorganic salt experience also desirably has or provides a predetermined minimum air pressure drop to meet specified operation requirements of HVAC systems, and can desirably be scaled up easily. The inorganic salt is also desirably able to operate with conditions well above salt saturation without moisture leaking out (condition of delinquency). It preferably operate at a conditions at least 120% above the saturation relative humidity.

In embodiments, inorganic salts are arranged in a cascade system using salts with different moisture absorption to provide efficient operation. Preferably combinations of salts include, without limitation, CaCl₂, SrBr₂, and CaBr₂.

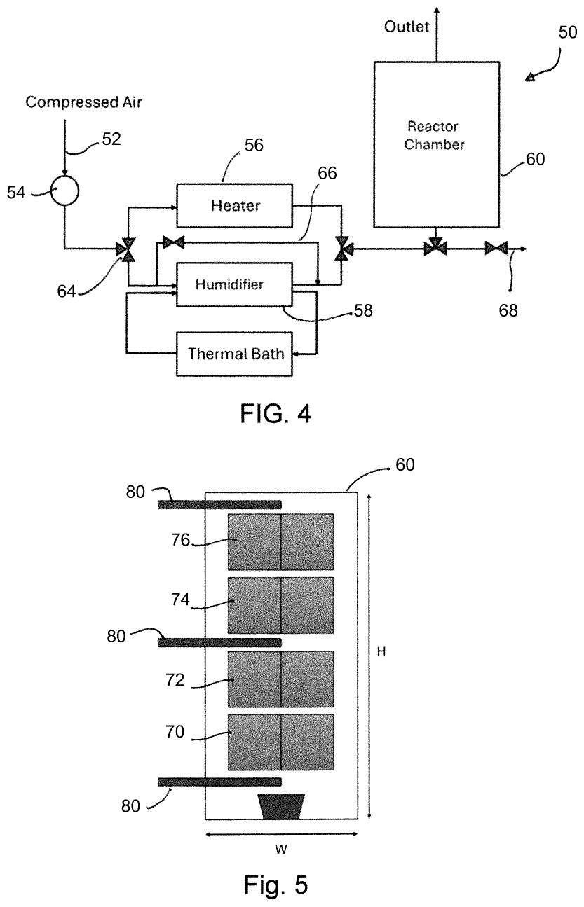

FIG. 4 illustrates a general outline of a thermochemical energy storage system 50 according to embodiments of this invention. Compressed air 52 from a compressed air system enters the system through an airflow meter 54, passes through a heater 56 (e.g., Cool Touch™ 150 Heat Torch), or a humidifier 58 (e.g., PermaPure FC150-480), and enters the reactor chamber 60. The humidifier 58 is connected to a water circulator or thermal bath 62 (e.g., Julabo F32-ME) that pumps deionized water through the humidifier 58 to humidify the air. The humidity is controlled by adjusting the water flowmeter and two-way valves 64 at the entrance of the humidifier 58, a humidifier bypass 66, and/or the direct line from the compressed air system. The system further includes a drain 68 for excess water collection in the reactor 60.

FIG. 5 shows the assembled TCM reactor 60 setup. As illustrated the reactor 60 includes four impregnated blocks 70, 72, 74, and 76, such as described above for FIGS. 2 and 3. Humidity and temperature sensors 80 (e.g., Rotronic HC2 screw-in probe with temperature accuracy of ±0.1° C. and relative humidity accuracy of ±0.8% RH, Pico Technology Type T thermocouple with accuracy of ±0.5%) are placed throughout the reactor chamber 60, such as placed at the inlet, in the middle, and at the outlet of the reactor chamber 60.

In embodiments, the reactor can include one salt or a cascade system of different hydrated salts. As shown the pair of blocks 70 and 72 include a different hydrated salt than the pair of blocks 74 and 76. For example, one pair of blocks can include CaCl₂·6H₂O and the other pair of blocks can include CaBr₂·6H₂O. Energy storage density and power density of the system can be improved through the application of the cascade system. In testing, at a high flow rate of 1000 L/min, the following were achieved for a cascade system: energy density of 350 kWh/m³ for air with 60% relative humidity (RH) and 150 kWh/m³ for air with 35% RH; peak power density of 120 kW/m³ for air with 60% RH and 80 kW/m³ for air with 35% RH; and peak temperature lift of 10° C. for air with 60% RH and 6° C. or air with 35% RH.

The present invention is described in further detail in connection with the following examples which illustrate or simulate various aspects involved in the practice of the invention. It is to be understood that all changes that come within the spirit of the invention are desired to be protected and thus the invention is not to be construed as limited by these examples.

### EXAMPLES

Calcium chloride hexahydrate (CaCl₂·6H₂O) was chosen as a TCES material because of its safety, cycling stability, low cost, and suitable theoretical energy density. Also, expanded graphite (EG) was used as a porous host structure. Expanded graphite (EG) is commonly used to enhance the heat transfer of materials. The thermal conductivity of the expanded graphite is extremely high and can vary from 140-500 W/(m·K) into the plane of the sheet while having a 3-10 W/(m·K) range in the perpendicular. In embodiments, the EG structure is of high thermal conductivity of not less than 10 J/m s C in one direction. EG can be easily obtained from the graphite flakes by mixing them with an intercalation agent and subsequent high-temperature shock treatment. The resulting EG has a worm-like structure with pores of different diameters. To achieve structural stability, the EG flakes were compressed to form an expanded graphite matrix of a certain density.

The prepared composite material underwent 90 hydration-dehydration cycles, which is believed to be higher than shown in other studies. Moreover, most of the performed cycles were carried out with CaCl₂ overhydration and deliquescence, which didn't show any major effect on the material stability. Both the composite material itself and its manufacturing process are simple and inexpensive, providing a downright opportunity for future commercialization.

### Materials and Methods

Thermogravimetric analysis was performed using TGA Q5000 (TA Instruments). The measurements were performed in the standard platinum pan (100 μL), in a range from room temperature to 300° C. Both pure CaCl₂·6H₂O and the composite with EG were tested with a heating rate of 1° C./min.

### First Generation: EG Slabs

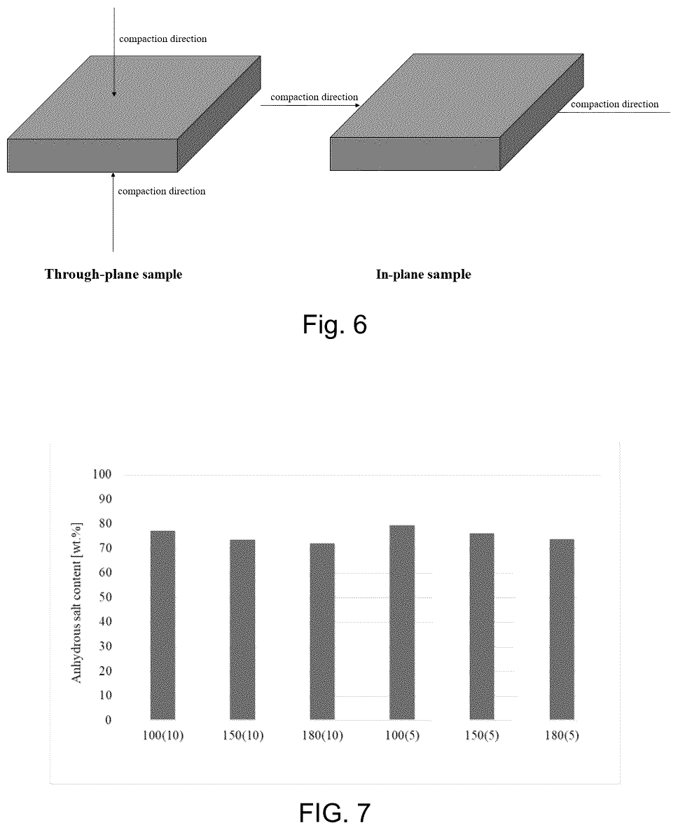

EG flakes were compacted to form the EG matrix with 100 g/l density. As the EG flakes were compacted uniaxially, it resulted in anisotropy of the blocks and a significant direction-dependency of thermal, mechanical, and electrical properties. That is why the terms “in-plane” (IP), and “through-plane” (TP) are introduced. “In-plane” indicates that the sample is cut in parallel to the graphite compaction layers, while in the case of a “through-plane” sample, it is done perpendicularly (see FIG. 6).

All the prepared composite (salt/EG) samples were in-plane (IP), since after the preliminary tests, they showed better water vapor diffusion through the graphite structure.

The EG/CaCl₂ composite materials were prepared by impregnating pre-cut EG samples with molten CaCl₂·6H₂O (Sigma Aldrich, 98% purity, CAS no. 774-34-7). Three graphite composite densities (100, 150, and 180 g/l) and two thicknesses (10 and 5 mm) of EG were developed. The EG samples were immersed in the molten salt in glass containers with lids and soaked for 72 hours. Subsequently, the composites were removed from the liquid salt and placed on metal trays for drying using a Quincy Lab 20GC oven. A stepwise heating program of 50° C. overnight, 90° C. for 5 h, and 150° C. for 1 h was used. This was employed to prevent vigorous heating which may lead to salt leakage/migration and pore blockage. The composite salt content was determined gravimetrically from the weights of the EG before and after impregnation and drying.

Table 1 contains the details of the prepared composite samples of CaCl₂ and EG of different densities. The size of the manufactured composite samples was approximately 150 mm×75 mm×10 mm and 150 mm×75 mm×5 mm.

TABLE 1
Description of the composite samples

| | | EG | Sample | Anhydrous |
|---|---|---|---|---|
| | Impregnation | density | thickness | salt content |
| Sample | type | [g/l] | [mm] | [wt. %] |
| CaM10010 | molten | 100 | 10 | 79.4 |
| CaM15010 | molten | 150 | 10 | 76.1 |
| CaM18010 | molten | 180 | 10 | 73.7 |
| CaM1005 | molten | 100 | 5 | 77.1 |
| CaM1505 | molten | 150 | 5 | 73.5 |
| CaM1805 | molten | 180 | 5 | 73.3 |

FIG. 7 shows the anhydrous CaCl₂ content in wt. % after impregnation and drying. All EG samples demonstrated excellent impregnation ability with a salt content between 70 and 80 wt. % depending on the initial EG matrix density. As expected, higher EG matrix density shows lower salt content: 72, 74, and 77 wt. % for 180, 150, and 100 g/l EG matrix density, respectively (10 mm samples). Thinner samples of 5 mm demonstrated slightly higher salt content with 79, 76, and 74 wt. % for 180, 150, and 100 g/l EG matrix density, respectively.

### Second Generation: Perforated EG Blocks

After initial hydration reactions performed in the humidity chamber, where the slabs demonstrated excellent energy density results but unsatisfactory mechanical stability due to slabs bending and deforming, the design of the EG matrix was changed. To ensure a reasonable heat transfer and good mechanical strength without compromising mass transfer rate and energy density, an innovative design of graphite block was used (see FIG. 3). Since 5 mm slabs proved to have acceptable moisture diffusion path length, the spacing between the through-holes was set to 5 mm.

To manufacture the blocks, the holes were drilled in parallel to the IP direction, since this direction proved to facilitate mass transfer. The manufactured perforated EG blocks were submerged into the molten CaCl₂·6H₂O for 72 hours and then dried in an oven at 150° C. The perforated block parameters after soaking and drying are shown in Table 1. The blocks are very similar in size, the only difference between them is a small variation in anhydrous salt content, which is common for the porous structure with some irregularities.

TABLE 2
Perforated block parameters after soaking and drying

| | | | | | Perforated | Perforated |
|---|---|---|---|---|---|---|
| | | Sample | | Anhydrous | block | block |
| | Impregnation | dimensions | EG density | salt content | volume | volume |
| Sample | type | [mm] | [g/l] | [wt. %] | (solid), [m³] | (total), [m³] |
| Block 1 | molten | 275 × 120 × 73 | 100 | 62.9 | 0.00171 | 0.00241 |
| Block 2 | molten | 274 × 119 × 74 | 100 | 66.1 | 0.00171 | 0.00241 |
| Block 3* | molten | 118 × 73 × 76 | 100 | 62.2 | 0.00047 | 0.00065 |

*Block 3 was cycled in the thermal chamber, while Blocks 1 and 2 were cycled in the reactor

### Thermochemical Reactor Design and Construction

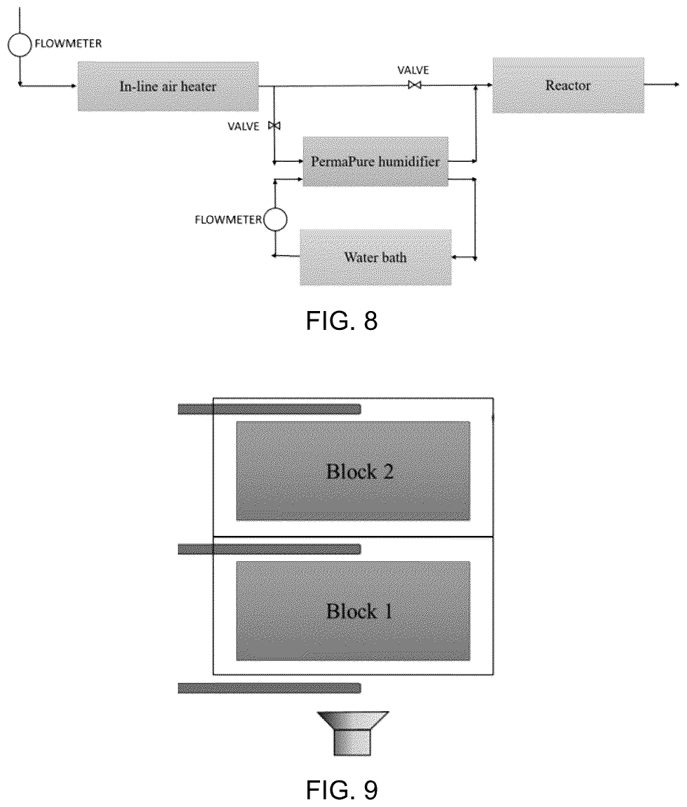

To examine the performance of the manufactured perforated composite material, a lab-scale open reactor was designed and built. FIG. 8 illustrates a general outline of the thermochemical reactor with its main components, similar to that described in FIG. 4. The air from a compressed air system enters the setup through an airflow meter, passes through a heater (Cool Touch™ 150 Heat Torch), or a humidifier (PermaPure FC150-480), and enters the reactor chamber. The humidifier is connected to a water circulator (Julabo F32-ME) that pumps deionized water through the humidifier to humidify the air. The humidity is controlled by adjusting the water flowmeter and two-way valves at the entrance of the humidifier and the direct line from the compressed air system. The humidity and temperature sensors (Rotronic HC2 screw-in probe with temperature accuracy of ±0.1° C. and relative humidity accuracy of ±0.8% RH, Pico Technology Type T thermocouple with accuracy of ±0.5%) were placed at the inlet, in the middle and at the outlet of the reactor chamber.

The reactor chamber contained four compartments that were insulated with two types of insulation: the first layer was ceramic fiber that minimizes heat losses from the system; the second layer was high-temperature polyimide foam that prevents the composite material damage due to its expansion during cycling. Each compartment (see two exemplary compartments of FIG. 9) accommodated one block of the composite material. Moreover, the reactor chamber was wrapped with a 1″ thickness ceramic fiber blanket, which served as a third layer of insulation.

The studied material underwent ninety hydration/dehydration cycles, which were carried out at different conditions of relative humidity, inlet temperature and airflow rate. The temperature and humidity measurements were logged every 5 seconds. The material was dehydrated until the inlet and outlet absolute humidities were equal, then the reactor was allowed to cool before starting the hydration. It should be indicated that the reactor and the block were cooled down with compressed air at room temperature and with an average relative humidity of 12-14% for approximately four hours. The average dehydration time and temperature were 4 hours and 150° C. The hydration reactions were performed overnight, with an average reaction time of 16 hours, and a range of relative humidity between 12 and 80%.

### Energy Analysis

### Hydration Reaction

During the hydration reaction, water vapor reacts with CaCl₂ in the graphite block exothermically. The released heat is used to heat both the air and the reactor and its contents. The energy balance for the hydration reaction is as follows:

$${Q}_{r e c o v e r e d} + {Q}_{s e n s i b l e} + {Q}_{l o s s} = {Q}_{reaction} \qquad ( 1 )$$

where Q_{recovered} is the sensible energy recovered by the outlet exit air, Q_{sensible} is the sensible heating of the composite material and the reactor, Qₗₒₛₛ refers to the heat losses to ambient, and Q_{reaction} refers to the overall heat of reaction between the composite material and water vapor. The calculation of Q_{recovered} is shown in the equation below:

$${Q}_{recovered} = \frac{{\dot{V}}_{a} ( {T}_{o u t} - {T}_{i n} ) ( 1.006 + 1.86 ( \frac{{χ}_{in} + {χ}_{out}}{2} ) )}{{v}_{da} \cdot {V}_{c o m}} \qquad ( 2 )$$

where \dot{V}ₐ refers to the volumetric flow rate of the inlet air, v_{da} refers to the specific volume of the inlet dry air, V_{com} refers to the volume of the material (bed volume), Tₒᵤₜ and Tᵢₙ refer to the outlet and inlet air temperatures and χ is the absolute humidity of the inlet or outlet air.

The sensible heating of the composite material and the reactor is calculated from the following equation:

$${Q}_{s e n s i b l e} = \frac{{m}_{c o m} {Cp}_{c o m} ( {T}_{c o m} - {T}_{a m b} )}{{V}_{c o m}} \qquad ( 3 )$$

where m_{com} is the mass of composite material, Cp_{com} is the heat capacity of the composite material, T_{com} is the temperature of the composite material, and T_{amb} is the temperature of the ambient air.

The heat losses to the surroundings are calculated from the equation below:

$${Q}_{l o s s} = \frac{0.000264 ( \frac{{T}_{in} + {T}_{out}}{2} {T}_{a m b} )}{{V}_{c o m}} \qquad ( 4 )$$

where the coefficient UA=0.000264 kW/K was calculated through experimental work. This was done by running dry air at 100° C. through an empty reactor and calculating the difference in temperature between the inlet and outlet air flows at a steady state (Eq. (5)):

$$UA = \frac{\frac{\dot{V} a}{{v}_{d a}} {Cp}_{c o m} ( {T}_{o u t} - {T}_{i n} )}{\frac{{T}_{in} + {T}_{out}}{2} - {T}_{a m b}} \qquad ( 5 )$$

The theoretical value was calculated through Eq. (6) and the resulting value was UA=0.000204 kW/K, which is in good agreement with the experimental value.

$$UA = \frac{1}{\frac{Δ X}{{k}_{1}} + \frac{Δ X}{{k}_{2}} + \frac{Δ X}{{k}_{3}}} \times L \times h \qquad ( 6 )$$

It should be noted that due to the absence of a temperature sensor in the block, its temperature is taken as an average between the inlet and the outlet temperature.

### Dehydration Reaction

During the dehydration reaction, dry hot air passes through the reactor, removing moisture from the composite block (endothermic process). The energy balance for the dehydration reaction is as follows:

$${Q}_{input} - {Q}_{s ensible} - {Q}_{loss} = {Q}_{reaction} \qquad ( 7 )$$

where Qᵢₙₚᵤₜ is the net energy input into the system during dehydration, Q_{sensible} is sensible heating of the material and the reactor, Qₗₒₛₛ represents heat losses to the surroundings (calculated from Eq. 4) and Q_{reaction} is the heat of dehydration reaction. Qᵢₙₚᵤₜ can be calculated from the following equation:

$${Q}_{input} = \frac{{\dot{V}}_{a} ( {T}_{i n} - {T}_{o u t} ) ( 1.02 + 1.9 ( \frac{{χ}_{in} + {χ}_{out}}{2} ) )}{{v}_{d a} \cdot {V}_{c o m}} \qquad ( 8 )$$

### Total Balance

The total volumetric energy density includes the heat recovered by the air in case of hydration, the energy input into the system in case of dehydration, the sensible heating of the reactor, and heat losses to the surroundings over the entire period of the reaction:

$${E}_{tot} ( hydration ) = {\int }_{0}^{16} {Q}_{recovered} + {\int }_{0}^{16} {Q}_{sensible hydr} + {\int }_{0}^{16} {Q}_{loss hydr} \qquad ( 9 )$$

$${E}_{tot} ( dehydration ) = {\int }_{0}^{4} {Q}_{input} - {\int }_{0}^{4} {Q}_{sensible hydr} - {\int }_{0}^{4} {Q}_{loss hydr} \qquad ( 10 )$$

$$The overall thermal efficiency is shown in Eq . ( 14 ) :$$

$$η = \frac{{\int }_{0}^{16} {Q}_{recovered} + {\int }_{0}^{16} {Q}_{sensible hydr} + {\int }_{0}^{16} {Q}_{loss hydr}}{{\int }_{0}^{4} {Q}_{input} - {\int }_{0}^{4} {Q}_{sensible dehydr} - {\int }_{0}^{4} {Q}_{loss dehydr}} \qquad ( 11 )$$

### TGA Analysis

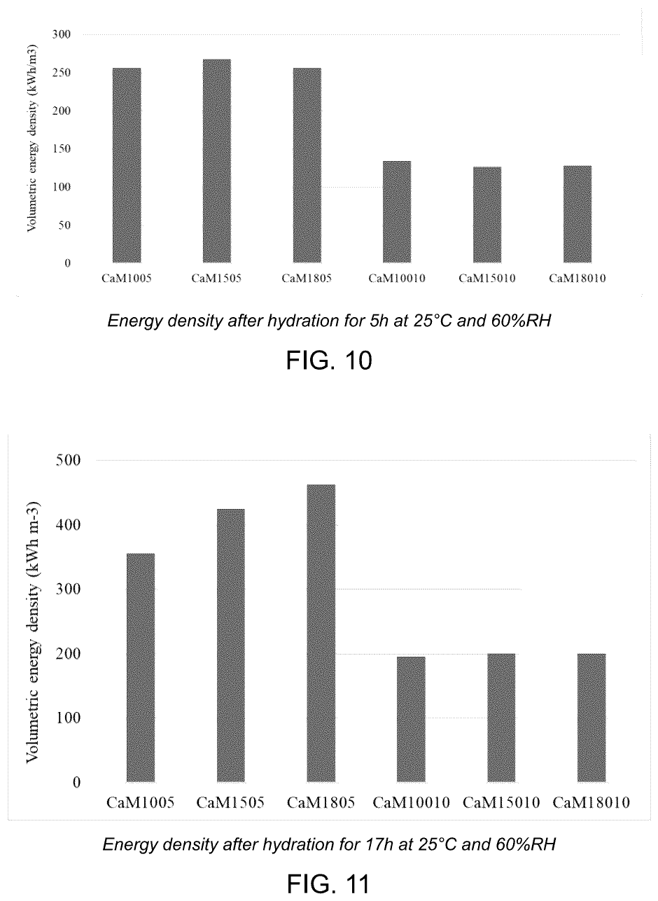

The energy density and cycling stability of the composite slabs were evaluated in the Thermotron SE-400-6-6 Environmental Test Chamber. Single hydration reactions (see examples in FIGS. 10-11) were performed at 25° C. and 60% RH with varying times to estimate the energy density of the composite. The properties of the composite samples are presented in Table 1.

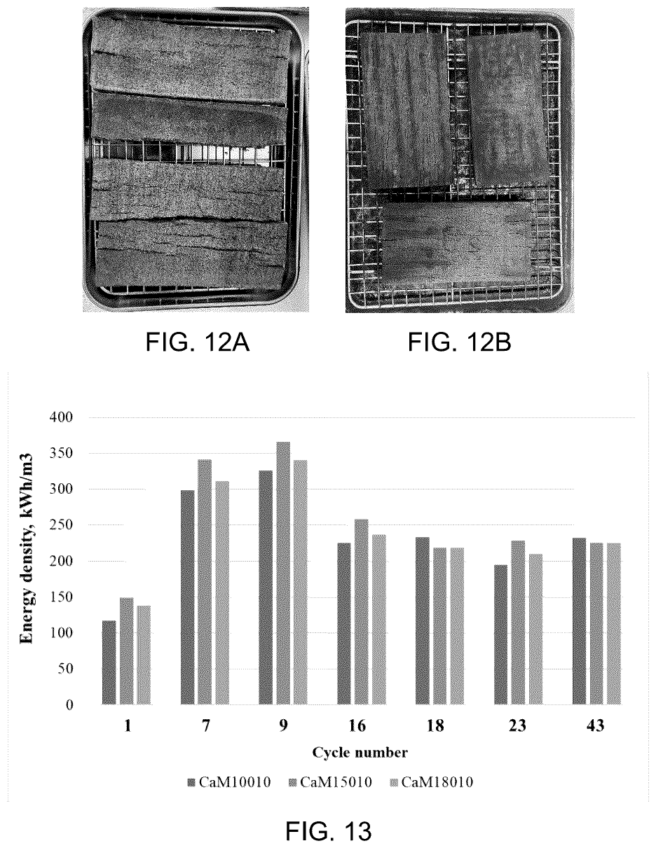

After completing single hydration reactions, the prepared composite salt/EG samples were subjected to continuous cycling using the following protocol:
Hydration reaction at 25° C. and 60% RH for 6 hours;
Ramp at 5° C./min to 100 C;
Dehydration reaction at 100° C. for 5 hours; and
Repeat.
   The 5 mm thick samples cracked and broke during the first 10 cycles (see FIGS. 12A (5 mm-thick samples) and 12B (10 mm-thick samples)).

The composite CaCl₂/EG 10 mm samples maintained structural stability even after 50 hydration-dehydration cycles, and demonstrated high energy density, due to the overhydration and deliquescence of CaCl₂. After the initial 10 cycles and a slight wash-out of CaCl₂) from the EG slabs, the energy density stabilized to around 220 kWh/m³ (FIG. 13). In addition, the final inspection of the composite CaCl₂/EG 10 mm samples revealed that the lowest EG density (100 g/l) performed the best in terms of mechanical stability since the slab didn't have any visible cracks, while the slabs with higher EG densities (150, 180 g/l), experienced multiple cracks due to EG expansion and contraction during cycling. Therefore, the next generation composite samples (perforated EG blocks) were manufactured using 100 g/l expanded graphite.

### Perforated EG Blocks (Second Generation) Cycling

To build a heat storage unit based on slabs of 5 mm or 10 mm and an air gap of 5 mm between them, the slab must remain very flat to prevent airflow blockage. Therefore, based on the experience with the slabs, the structured packing (perforated blocks) described earlier were used as a second-generation composite.

The hydration reactions for the perforated block were performed in the Thermotron SE-400-6-6 Environmental Test Chamber; the dehydration reactions were performed in a Quincy Lab 20GC oven:
Hydration reaction at 20° C. and 40% RH for 17 hours;
Dehydration reaction at 150° C. overnight; and
Repeat.

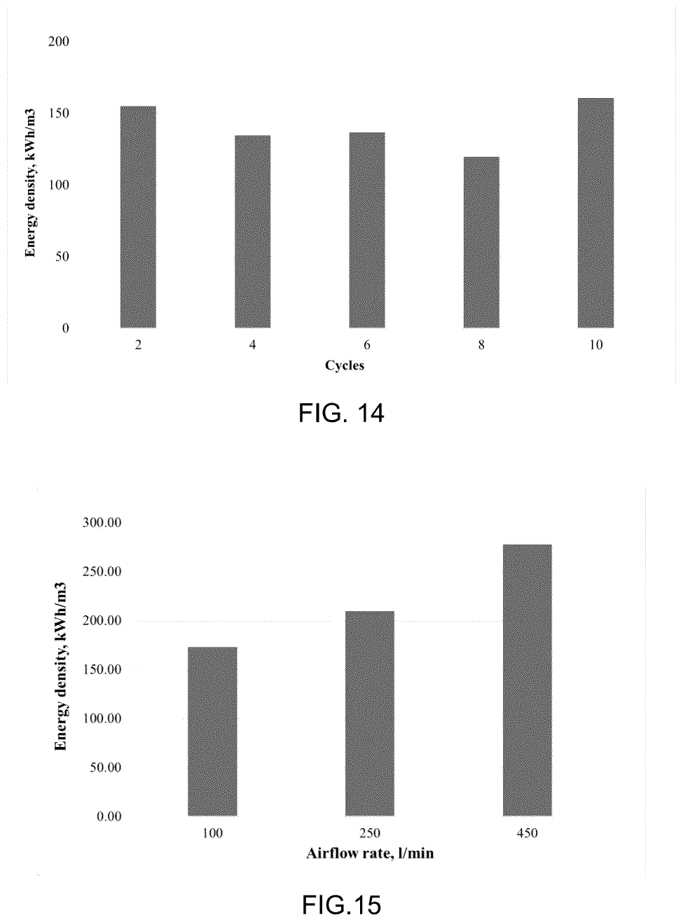

The energy density of the perforated composite block during 10 cycles is presented in FIG. 14. The block showed excellent structural stability with no signs of degradation, with an energy density between 120 and 160 kWh/m3.

Since the initial testing of the perforated composite block performed in the environmental chamber was promising and demonstrated satisfactory results, it was decided to take it to the next stage and perform extensive cycling in the TCM reactor.

### Perforated EG Cycling in the Reactor

The cycling of the perforated blocks was performed in the reactor during 90 hydration-dehydration reactions. The energy density of the block was monitored through hydration reactions performed at similar conditions of absolute humidity and inlet temperature; the block integrity was checked by visual inspection after removing it from the reactor. The energy density used for comparison was volume-based rather than mass-based, which is needed in the design of any storage unit. We have also reported the mass-based energy density to compare to other reported values using TGA-DSC analysis (Table 3). Both theoretical energy density values are derived from the full hydration reaction and formation of the solid salt, CaCl₂·6H₂O

TABLE 3
Perforated blocks parameters

| | | | Mass of | | Theoretical | Theoretical |
|---|---|---|---|---|---|---|
| | | | H₂O | | energy | energy |
| | Anhydrous | | required | | density | density |
| | salt | Mass of | for full | Heat of | (material | (system |
| | content | anhydrous | hydration, | reaction, | level), | level), |
| Sample | [wt.%] | salt, [kg] | [kg] | [kJ/kg] | [kWh/m³] | [kWh/m³] |
| Block 1 | 62.9 | 0.3697 | 0.3595 | 3200 | 186.9 | 132.6 |
| Block 2 | 66.1 | 0.4325 | 0.4206 | 3200 | 218.2 | 154.9 |

During the cycling of the composite blocks in the TCM reactor, we evaluated the effect of s airflow rate, relative humidity, and inlet temperature on the energy density, power density, and temperature lift, as described in the following sections.

### Effect of the Airflow Rate

The energy density should be independent of the airflow rate, however, FIG. 15 shows an increase in energy density as the airflow rate increases. The higher flow rates are expected to increase heat and mass transfer rates. As a result, an increase in air flow rate results in an increase in instantaneous power output. This leads to an increase in volumetric energy density for the same given time. If the lower airflow rate is continued for longer periods, the block will have similar energy density at the various flow rates.

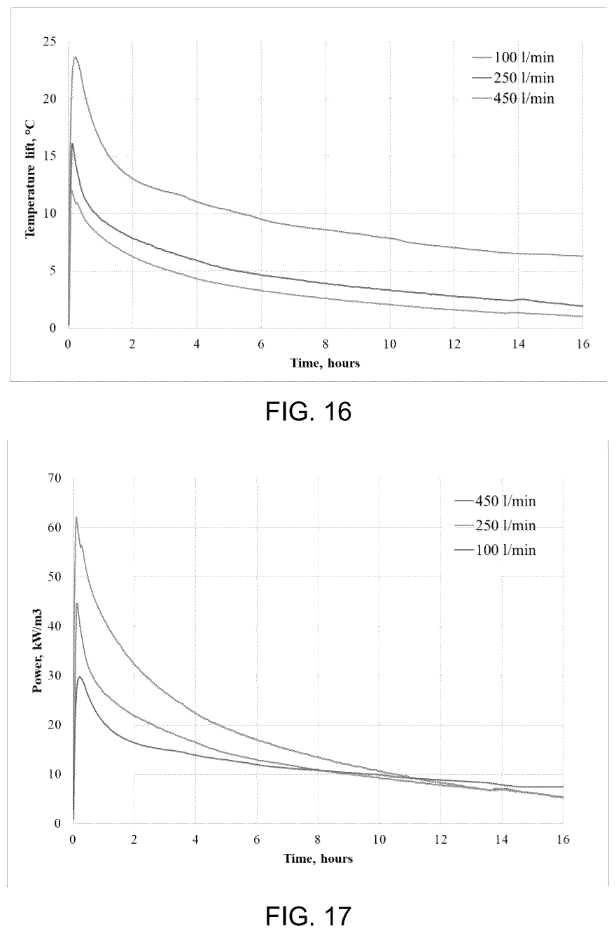

The temperature lift dependence on the airflow rate is demonstrated in FIG. 16. The lower airflow rate corresponds to the higher temperature increase, which is expected since the airflow rate is inversely proportional to temperature lift (Eq. (2)).

The increase in the instantaneous power output at higher flow rates shown in FIG. 17 is anticipated since the power is a function of air flowrate (Eq. (2)); this was also shown by other authors for other materials. The temperature lift and power density are high during the first few hours but tend to decline for the remaining period. The hydration reaction of CaCl₂ does not take place in a single step but shows several levels of hydration. The rapid increase in outlet temperature is due to the reaction of 1 and 2 moles of water, which is known to be very fast even at low humidity and occurs over the whole body of the graphite block, unlike the reaction from 2 to 6 moles. For the reaction of 2-6 moles of water, the reaction is slower and occurs only at the inlet section of the reactor and progresses to other parts of the block gradually.

### Effect of Relative Humidity

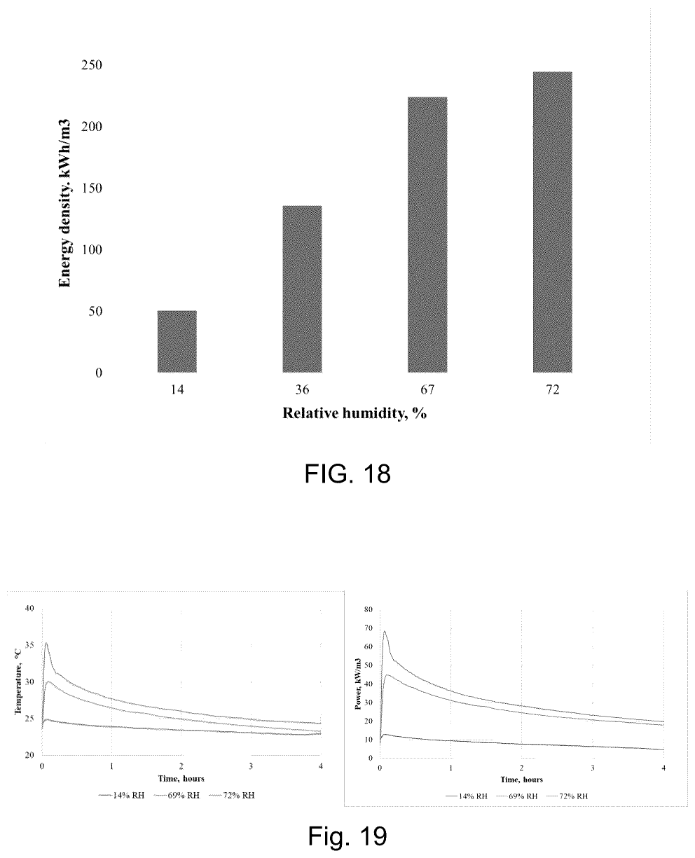

Increasing relative humidity shows a significant increase in the energy density of the block (FIG. 18), exceeding the theoretical value due to CaCl₂ overhydration. According to the equilibrium phase diagram of CaCl₂) and its hydrates, a full hydration reaction with the formation of CaCl₂·6H₂O occurs at very low relative humidity (20° C. and ˜ 20% RH). However, in the case of composite materials, there is a significant mass transfer limitation, which slows down the reaction time, especially at low RH values, making it impractical to perform. At higher RH values, when P>>Peq, there is a large thermodynamic driving force for hydration. This increased driving force results in increased temperature lift and instantaneous power output.

On the other hand, as can be seen in FIG. 19, the increase in humidity directly affects the temperature lift and power output during the hydration reaction.

### Effect of the Second Perforated Block

The first twenty-six cycles were performed with only one block in the reactor chamber; starting from cycle number 27, the second composite block was added to the reactor chamber.

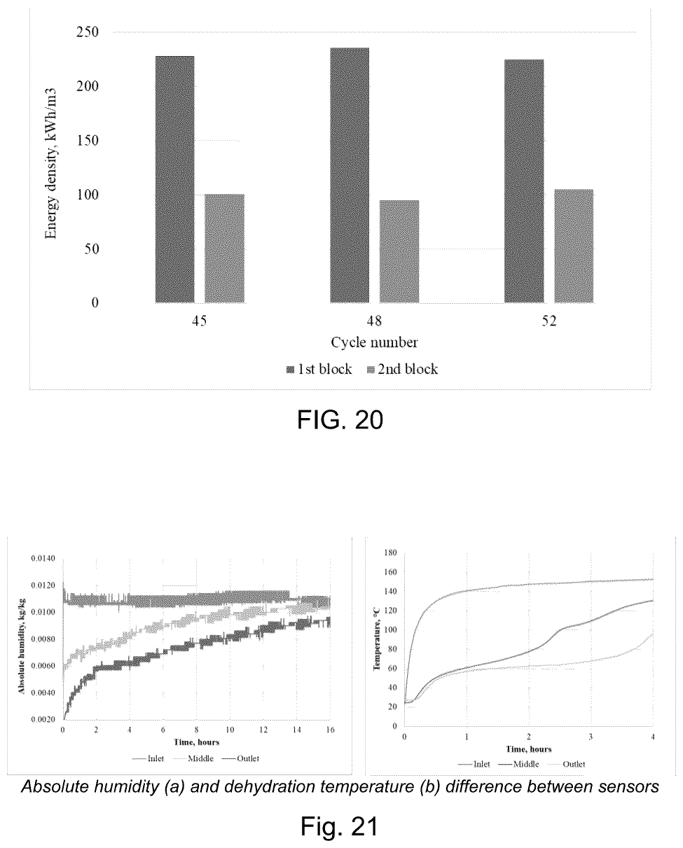

The TCM blocks are almost identical in size and were impregnated with a similar amount of salt (see Table 3) so they should have similar energy density values. However, FIG. 20 shows that the energy density of the second block is less than half of that of the first one.

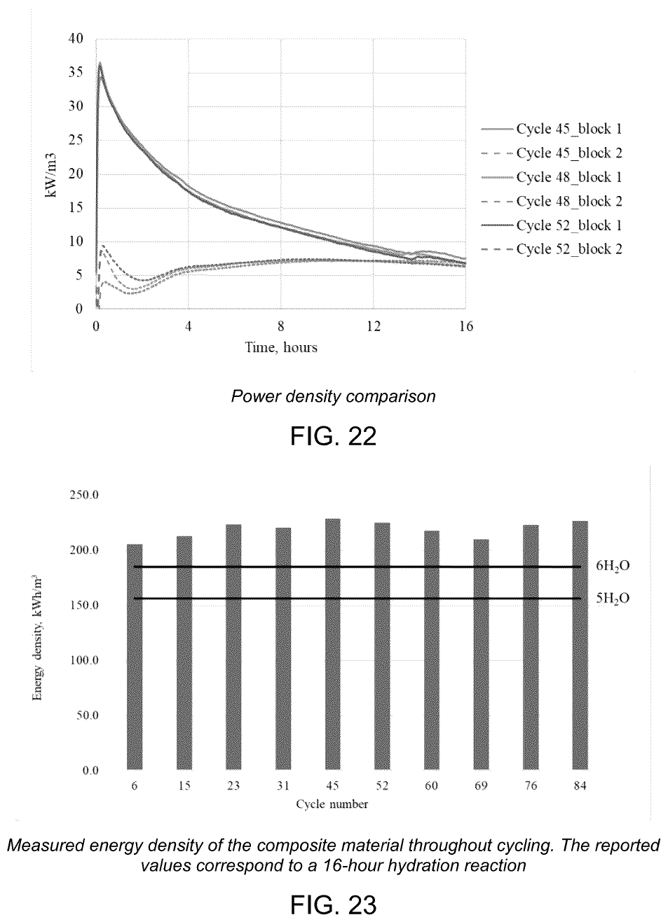

The same may be said about the power density shown in FIG. 22. Our explanation is that the second block receives air with much lower humidity during hydration and receives air with lower temperature during dehydration, and as a result, both caused the second block to be inferior in performance (see FIG. 21). If the process is continued for an extended period, the energy density of the second block will be similar to the first one.

### Cycling Performance

The composite block underwent 90 hydration-dehydration reactions. To ensure composite material cycling stability, the energy density of the block was measured during hydration at similar conditions of absolute humidity and inlet temperature (see Table 4 and FIG. 23); the block integrity was also monitored by visual inspection after removing it from the reactor chamber after every few cycles.

TABLE 4
Composite block energy density throughout the cycling

| | Energy density per | Energy density | | | |
|---|---|---|---|---|---|
| | solid volume | per total | Absolute | Inlet | Airflow |
| | (material level), | volume, | humidity, | temperature, | rate, |
| Cycle | kWh/m³ | kWh/m³ | kg/kg | ° C. | l/min |
| 6 | 205.1 | 144.8 | 0.009 | 19 | 400 |
| 15 | 212.5 | 150.0 | 0.010 | 20 | 400 |
| 23 | 222.8 | 157.3 | 0.009 | 18 | 400 |
| 31 | 220.3 | 155.5 | 0.010 | 19 | 400 |
| 45 | 228.2 | 161.1 | 0.010 | 22 | 400 |
| 52 | 224.7 | 158.7 | 0.010 | 21 | 400 |
| 60 | 217.5 | 153.5 | 0.010 | 22 | 400 |
| 69 | 209.7 | 148.1 | 0.009 | 20 | 400 |
| 76 | 222.5 | 157.1 | 0.011 | 21 | 400 |
| 84 | 226.3 | 159.8 | 0.010 | 20 | 400 |
| Average | 219.0 | 154.6 | 0.010 | 20 | 400 |

As can be seen from Table 4 and FIG. 19, the energy density of the block didn't change significantly during cycling, which indicates excellent stability of the composite material even after 90 hydration-dehydration reactions. The average energy density of the composite material at the indicated conditions is 219 kWh/m³, which exceeds the theoretical value of 186.9 kWh/m³ (for 6 moles of H₂O), due to CaCl₂) being overhydrated.

Moreover, it should be indicated that following each dehydration, the block was cooled down with compressed air at room temperature having an average relative humidity of 12-14% for approximately four hours.

To estimate the amount of water reacting during this cooling period, the hydration reaction was performed by running the “dry” air from the compressed air system through the block overnight without passing through the hydration unit. The total energy density generated after 16 hours of such reaction was 55 kWh/m³, while the energy density after 4 hours (average cooling time) was 32 kWh/m³. These values correspond approximately to the heat generated from the absorption of 2 and 1 moles of water.

The composite block demonstrated excellent mechanical stability even after 90 cycles, even though CaCl₂) was overhydrated and experiencing delinquency. Some minor EG cracks formed due to CaCl₂) volume change during hydration-dehydration, however, those do not affect the overall material stability.

### Energy Density and Thermal Efficiency Analysis

This section contains the results of energy density and thermal efficiency analysis for the selected cycles with varying values of relative humidity, inlet temperature, and airflow rate, that were discussed above (see Table 5).

The dehydration temperature was kept constant during the cycling. All values for energy density are calculated for the hydration reaction time of 16 hours and the dehydration reaction time of 4 hours.

TABLE 5
Energy density and thermal efficiency analysis

| | Abs. | Inlet | Airflow | Volumetric energy | | Sensible heat, | | Heat loss, | | |
|---|---|---|---|---|---|---|---|---|---|---|
| | humidity, | T, | rate, | density, kWh/m3 | | kWh/m3 | | kWh/m3 | | Therm. |
| Cycle | kg/kg | ° C. | l/min | Hyd. | Dehyd. | Hyd. | Dehyd. | Hyd. | Dehyd. | eff. |

Inlet temperature influence

| | | | | | | | | | | |
|---|---|---|---|---|---|---|---|---|---|---|
| 38 | 0.006 | 23 | 400 | 135.5 | 202.2 | 0.2 | 16.7 | 1.9 | 23.7 | 0.8 |
| 36-37 | 0.007 | 13 | 400 | 235.5 | 267.3 | −1.3 | 17.1 | −7.7 | 21.8 | 1.0 |
| (avg) | | | | | | | | | | |
| 40-41 | 0.008 | 14 | 400 | 242.3 | 285.9 | −1.2 | 17.1 | −5.9 | 23.1 | 1.0 |
| (avg) | | | | | | | | | | |

Effect of relative humidity

| | | | | | | | | | | |
|---|---|---|---|---|---|---|---|---|---|---|
| 90 | 0.0023 | 22 | 400 | 50.7 | 138.8 | −0.5 | 18.5 | −0.8 | 26.1 | 0.5 |
| 38 | 0.0062 | 23 | 400 | 135.5 | 202.2 | 0.2 | 16.7 | 1.9 | 23.7 | 0.8 |
| 18 | 0.0097 | 20 | 400 | 223.8 | 245.0 | −0.2 | 9.9 | −0.5 | 13.8 | 1.0 |
| 83 | 0.0100 | 20 | 400 | 230.2 | 286.8 | −1.8 | 17.0 | −1.7 | 22.1 | 0.9 |
| 77 | 0.0110 | 20 | 400 | 244.4 | — | −0.5 | — | −1.1 | — | — |

Effect of airflow rate

| | | | | | | | | | | |
|---|---|---|---|---|---|---|---|---|---|---|
| 1 | 0.0091 | 20 | 100 | 172.9 | — | −0.4 | — | 1.9 | — | — |
| 21 | 0.0102 | 22 | 250 | 209.3 | 238.0 | −1.6 | 17.3 | 0.6 | 23.6 | 1.0 |
| 25 | 0.0097 | 21 | 450 | 277.6 | — | 0.0 | — | −0.2 | — | — |

When calculating thermal efficiency, we have assumed that heat loss through insulation is useful energy and can be recovered. This is because the heat loss is large for our lab-scale reactor, but when scaling up to the industrial-scale reactor, the heat losses will be negligible. High humidity and low inlet temperature demonstrate higher thermal efficiency values, due to high energy density during hydration reaction. At low humidity, low energy density during hydration cannot compensate for high losses during dehydration, resulting in lower thermal efficiency.

The sensible heating of the reactor bed during dehydration was assumed to be lost during the following period. This is because once the dehydration reaction was completed the airflow was turned off, and the system was left to cool down.

Thus, the invention provides a suitable TCES system having efficient and low cost materials and design.

The invention illustratively disclosed herein suitably may be practiced in the absence of any element, part, step, component, or ingredient which is not specifically disclosed herein.

While in the foregoing detailed description this invention has been described in relation to certain preferred embodiments thereof, and many details have been set forth for purposes of illustration, it will be apparent to those skilled in the art that the invention is susceptible to additional embodiments and that certain of the details described herein can be varied considerably without departing from the basic principles of the invention.

What is claimed is:

1. A chemical-based energy storage system, comprising a porous matrix structure impregnated with a thermochemical material.

2. The system of claim 1, wherein the thermochemical material stores and releases thermal energy though a reversible chemical reaction.

3. The system of claim 1, wherein the thermochemical material comprises a salt hydrate.

4. The system of claim 3, wherein the thermochemical material absorbs thermal energy during a dehydration reaction and discharges stored energy through a hydration reaction.

5. The system of claim 3, wherein the salt hydrate comprises an inorganic salt selected from calcium salts, magnesium salts, sodium salts, strontium salts, lithium salts, and combinations thereof.

6. The system of claim 3, wherein the salt hydrate comprises sodium phosphate, strontium bromide, strontium chloride, calcium chloride, magnesium sulfate, or combinations thereof.

7. The system of claim 3, wherein the salt hydrate comprises calcium chloride hexahydrate.

8. The system of claim 3, wherein the salt hydrate comprises an inorganic salt that does not leak out from the porous matrix structure during hydration and dehydration, preferably with a percentage loss not exceeding 5% over 200 cycles.

9. The system of claim 3, wherein the salt hydrate is mechanically stable during hydration/dehydration over 400 cycles.

10. The system of claim 3, wherein the salt hydrate comprises a predetermined minimum air pressure drop.

11. The system of claim 3, wherein the salt hydrate is configured to operate above salt saturation without moisture leaking out, preferably being operable at a condition at least 120% above a saturation relative humidity.

12. The system of claim 1, wherein the thermochemical material comprises a plurality of inorganic salts having different moisture absorptions to provide efficient operation.

13. The system of claim 1, wherein the porous matrix comprises an expanded graphite structure having a thermal conductivity of not less than 10 J/m s C in one direction.

14. The system of claim 1, wherein the porous matrix comprises a plurality of through air passages.

15. The system of claim 14, wherein the porous matrix comprises an expanded graphite block with a plurality of air passages extending through the block from a first side to a second side.

16. A chemical-based energy storage system, comprising:
a porous expanded graphite matrix structure impregnated with a thermochemical salt hydrate; and
a plurality of air passages extending through the porous expanded graphite matrix structure.

17. A method of forming a thermochemical energy storage system, comprising:
impregnating a porous matrix structure with a salt hydrate; and
forming air passages through the porous matrix structure.
